(19) United States
(12) Patent Application Publication
(10) Pub. No.: US 2008/0180019 A1
(43) Pub. Date: Jul. 31, 2008

(54) Image display device

(75) Inventors: Shigemi Hirasawa, Chiba (JP); Hiroshi Ito, Chiba (JP)

Correspondence Address: MILBANK, TWEED, HADLEY & MCCLOY, 1 CHASE MANHATTAN PLAZA, NEW YORK, NY, 10005-1413, US

(73) Assignee: Hitachi Displays, Ltd.

(21) Appl. No.: 11/900,069

(22) Filed: Sep. 10, 2007

(30) Foreign Application Priority Data
Sep. 20, 2006 (JP) 2006-254206

(51) Int. Cl. H01J 63/06

(52) U.S. Cl. 313/496

(57) ABSTRACT

In the case of a flat panel display having an vacuum envelope in which electron sources are formed in a matrix, it is difficult to control the distance between the front substrate and the rear substrate in and around the effective screen area. Spacers are arranged both in and around the effective display area 6. Inner spacers 12 are arranged in the effective display area 6 while outer spacers 13 are arranged around the effective display area 6. The distance between the front substrate 2 and the front substrate 1 in the peripheral area is controlled by the outer spacers 13. This can solve various problems including the electrification of spacers 12 which may occur if the distance between the front substrate 2 and the front substrate 1 is not uniform.

### CLAIM OF PRIORITY

The present application claims priority from Japanese Application JP 2006-254206 filed on Sep. 20, 2006, the content of which is hereby incorporated by reference into this application.

### BACKGROUND OF THE INVENTION

1. Field of the Invention

The present invention relates to the structure of an internally vacuum flat-type display device which comprises a rear substrate having electron sources disposed in a matrix thereon and a front substrate having corresponding phosphors thereon and can endure atmospheric pressure.

2. Description of the Related Art

As an image display device which exhibits excellent characteristics such as high brightness and high definition, the color cathode ray tube has been widely used. However, due to the recent progress of information processing and television broadcasting in image quality, there has been an intensifying demand for flat panel displays (FPDs) which are light-weight and space-saving while possessing such characteristics as high brightness and high definition.

Their typical examples are liquid crystal display devices and plasma display devices which have been commercialized. Further, various self-luminous flat panel displays are under development for commercialization due to their potential superiority in brightness. They include field emission display devices (including what is called the surface-conduction electron-emitter display), which use electrons emitted from electron sources into vacuum space, and organic EL displays which are characterized by low power consumption.

As known, the field emission flat panel display, a type of self-luminous display, has electron sources arranged in a matrix.

The electron sources used as cold cathodes in field emission flat panel displays include Spindt type, surface conduction type, carbon nanotube type, MIM (Metal-Insulation-Metal) multi-layered type, MIS (Metal-Insulator-Semiconductor) type and metal-insulator-semiconductor-metal multi-layered type ones.

A field emission flat panel display has a display panel composed of a rear substrate, a front substrate and a support frame. The rear substrate has electron sources provided thereon as mentioned above. The front panel has a phosphor layer and anode provided thereon. The anode constitutes an acceleration electrode to bombard the phosphor layer with electrons emitted from electron sources. The support frame is a sealing frame to form a closed internal vacuum space between the rear and front substrates. The field emission flat panel display is driven by a drive circuit combined with this display panel.

For example, the rear substrate in a MIM electron source-used image display device has: a large number of first electrodes (for example, cathode electrodes or image signal electrodes) extended in a first direction and arranged in parallel in a second direction crossing the first direction; an insulation film formed to cover the first electrodes; a large number of second electrodes (for example, gate electrodes or scan signal electrodes) extended in the second direction and arranged in parallel in the first direction; and electron sources each formed in the vicinity of an intersection of the first and second electrodes. The rear substrate on which the above-mentioned electrodes are formed is made of insulation material.

To the scan signal electrodes in this configuration, the scan signal is sequentially applied. In the vicinity of each intersection of the scan signal electrode and image signal electrode, an electron source is formed. Current is supplied to each electron source via a supply electrode connected between the electron source and a scan signal electrode. The front substrate arranged to face the rear substrate has phosphor layers of plural colors and a third electrode (anode electrode or positive electrode) formed on the inner side thereof. The front substrate is formed of a light-transmitting material, preferably glass. The space between the two substrates is surrounded by the support frame inserted between them. The inner space formed by the rear substrate, the front substrate and the support frame is vacuumized to complete the display panel.

Each electron source is located in the vicinity of an intersection of the first electrode and second electrode. The amount of electrons emitted from the electron source (including turning on/off the emission) is controlled by the potential difference between the first electrode and the second electrode. Emitted electrons are accelerated by a high voltage applied to the positive electrode on the front substrate so as to strike a phosphor layer on the front substrate. Consequently, the phosphor layer is excited to emit light in the color determined by its emission spectrum.

With an associated phosphor layer, each electron source constitutes a unit pixel. Usually, three color unit pixels of red (R), green (G) and blue (B) constitute one pixel (color pixel). When color pixels are called pixels, unit pixels are sometimes called sub-pixels.

Usually, a flat panel display as described above has a plurality of spacing members (hereinafter denoted as spacers) disposed/fixed in the display region surrounded by the rear and front substrates and the support frame. In cooperation with the support frame, these spacers maintain a given distance between the two substrates. Typically, these spacers are thin plates made of glass or ceramic and located at intervals of a few pixels so as not to disturb each pixel's operation.

By using a sealing material such as frit glass, the support frame which also serves as a sealing frame is bonded to a rim of the rear substrate and to that of the front substrate. Thus, the joined portions are hermetically sealed. The display region formed by the two substrates and the support frame is vacuumized to, for example, 10⁻³-10⁻⁵ Pa.

First and second lead terminals connected respectively to the first and second electrodes are also formed on the rear substrate. Usually, the sealing support frame is bonded to both rear and front substrates by using a sealing material such as frit glass. Of the joined portions, the first lead terminals and second lead terminals are taken out through the joined portion between the support frame and the rear substrate.

As for the above-mentioned spacers, construction methods, setting methods and the like are disclosed in JP-A-1999-67125 and JP-A-2006-59728. These spacers are located within the effective display area in order to maintain a given distance between the front and rear substrates against the atmospheric pressure. On the other hand, the sealing frame is located around the effective display area in order to serve not only to maintain the vacuum in the display panel but also to maintain a given distance between the front and rear substrates against the atmospheric pressure. Therefore the sealing frame is thicker than the spacers since sufficient air tightness must be secured against the atmosphere. In addition, since the sealing frame is much different in shape from the spacers, they are sometimes made of different materials.

As described above, although the function to maintain a certain distance between the front and rear substrates is common to the spacers and the sealing frame, there are many situational differences between them. This has resulted in such related art techniques as described in JP-A-1999-317164 and JP-A-2002-358915. In the former technique, the bonding material used to bond the spacers to the front and rear substrates is different in properties from the bonding material for the sealing frame. In the latter technique, the height of the sealing frame is different from that of the spacers.

### SUMMARY OF THE INVENTION

Both the sealing frame and the spacers have the function to maintain a give distance between the front and rear substrates. They are bonded to the front and rear substrates by using sealing or bonding material. Generally, this sealing or bonding material is frit glass. After pasty frit glass is applied, baking is done at high temperature to melt the frit glass. Then, cooling is done to bond the sealing frame and spacers by the frit glass solidified.

However, the sealing frame is 5 mm or larger in thickness while each spacer is as about 0.1 mm. This large thickness difference leads to a substantial difference in calorific capacity between the sealing frame and each spacer. Therefore, if the front and rear substrates, the sealing frame and the spacers are assembled and heated, there occurs a difference between the time when the frit glass for the sealing frame melts and the time when the frit glass for the spacers melts. The process of melting and solidifying frit glass in order to bond the sealing frame and the spacers to the front and rear substrates causes frit glass protrusions around the sealing frame and each spacer. If the amount of protrusion differs between the sealing frame and each spacer, the inter-substrate distance held by the spacers is different from that held by the sealing frame.

JP-A-1999-317164 discloses the use of different frit glasses for the sealing frame and the spacers, respectively. These frit glasses differ in melting and solidification points. However, it is very difficult to finely control the melting and solidification points of a frit glass by varying the composition.

JP-A-2002-358915 discloses the sealing frame higher than the spacers in order to reliably maintain the vacuum in the space closed by the front and rear substrates and the sealing frame in the display device. However, this configuration sometimes results in spacers bonded poorly with the front or rear substrate.

Spacers, if charged, may affect the trajectories of electron beams. In this case, electrons may strike non-target phosphors, causing bad effects such as deteriorated color purity. To prevent this, each spacer is formed to have a conductive surface and given a constant voltage from the rear substrate. Accordingly, the frit used to bond each spacer is designed to have conductivity. However, if a spacer is poorly bonded to the rear substrate, the constant voltage may not be applied to the spacer due to insufficient electrical connection between the spacer and the rear substrate. If the constant voltage is not applied to the spacer, deteriorated color purity and other problems may occur since the trajectories of adjacent electron beams are affected.

Accordingly, the present invention was made to solve the above-mentioned conventional problem. With spacers arranged also around the effective screen, the present invention makes it possible to control the distance between the front and rear substrates without depending on the frame which constitutes an envelope. Specifically, the present invention provides:

(1) A display device comprising: a front substrate; a rear substrate; a peripheral frame, provided between the front substrate and the rear substrate, which constitutes an envelope to maintain a vacuum therein; electron sources which are arranged in a matrix on the rear substrate; phosphors which are arranged on the front substrate in association with the electron sources; an effective screen area which is constituted of the electron sources arranged in a matrix and the phosphors; a peripheral area between the effective screen area and the frame; inner spacers which are arranged in the effective screen area to maintain space between the front substrate and the rear substrate; and outer spacers which are arranged in the peripheral area to maintain space between the front substrate and the rear substrate.
(2) A display device as described in (1), wherein the inner spacers and the outer spacers are plate-like spacers.
(3) A display device as described in (1), wherein the inner spacers and the outer spacers are plate-like spacers and the inner spacers and the outer spacers are the same in terms of length, thickness and height.
(4) A display device as described in (1), wherein the outer spacers are higher than the inner spacers.
(5) A display device as described in (1), wherein the outer spacers are higher than the inner spacers by 10 μm-50 μm.
(6) A display device as described in (2), wherein each of the outer spacers has a length of 20 mm or more.
(7) A display device as described in (1), wherein the outer spacers are arranged at intervals of 3 mm-50 mm.
(8) A display device as described in (1), wherein the inner spacers are arranged at intervals of 3 mm-50 mm.
(9) A display device as described in (1), wherein the outer spacers are distant from the frame by 3 mm or more.
(10) A display device as described in (1), wherein the outer spacers are distant from the effective screen area by 3 mm or more.
(11) A display device as described in (2), wherein the outer spacers are laid in parallel with the inner spacers.
(12) A display device as described in (2) wherein the outer spacers are laid orthogonally to the inner spacers.
(13) A display device comprising: a front substrate; a rear substrate; a peripheral frame, provided between the front substrate and the rear substrate, which constitutes an envelope to maintain a vacuum therein; plural image signal lines which are laid in a first direction and arranged in a second direction on the rear substrate; plural scan lines which are laid in the second direction and arranged in the first direction on the rear substrate; electron sources each of which is formed in the vicinity of an intersection of the scan lines and the image signal lines; phosphors which are arranged on the front substrate in association with the electron sources; an effective screen area which is constituted of the electron sources arranged in a matrix and the phosphors; a peripheral area between the effective screen area and the frame; inner spacers which are arranged in the effective screen area to maintain space between the front substrate and the rear substrate; and outer spacers which are arranged in the peripheral area to maintain space between the front substrate and the rear substrate.
(14) A display device as described in (13), wherein the inner spacers are plate-like spacers which are formed respectively on some of the scan lines.
(15) A display device as described in (13), wherein the outer spacers are laid on dummy scan lines formed in parallel with the scan lines on the rear substrate, the outer spacers are electrically connected with the dummy scan lines and the a certain voltage is applied to the dummy scan lines.
(16) A display device comprising: a front substrate; a rear substrate; a peripheral frame, provided between the front substrate and the rear substrate, which constitutes an envelope to maintain a vacuum therein; plural image signal lines which are laid in a first direction and arranged in a second direction on the rear substrate; plural scan lines which are laid in the second direction and arranged in the first direction on the rear substrate; electron sources each of which is formed in the vicinity of an intersection of the scan lines and the image signal lines; phosphors which are arranged on the front substrate in association with the electron sources; a black matrix which is formed so as to surround each of the phosphors; an effective screen area which is constituted of the electron sources arranged in a matrix and the phosphors; a peripheral area between the effective screen area and the frame, including an inner peripheral area where the black matrix is extended beyond the effective screen area; inner spacers which are arranged in the effective screen area to maintain space between the front substrate and the rear substrate; and outer spacers which are arranged in the inner peripheral area to maintain space between the front substrate and the rear substrate.
(17) A display device as described in (16), wherein the outer spacers are electrically connected with the black matrix.
(18) A display device comprising: a front substrate; a rear substrate; a peripheral frame, provided between the front substrate and the rear substrate, which constitutes an envelope to maintain a vacuum therein; plural image signal lines which are laid in a first direction and arranged in a second direction on the rear substrate; plural scan lines which are laid in the second direction and arranged in the first direction on the rear substrate; electron sources each of which is formed in the vicinity of an intersection of the scan lines and the image signal lines; phosphors which are arranged on the front substrate in association with the electron sources; a black matrix which is formed so as to surround each of the phosphors; a metal back which is formed as to cover the phosphors and the black matrix; an effective screen area which is constituted of the electron sources arranged in a matrix and the phosphors; a peripheral area between the effective screen area and the frame, including an inner peripheral area where the black matrix and the metal back are extended beyond the effective screen area; inner spacers which are arranged in the effective screen area to maintain space between the front substrate and the rear substrate; and outer spacers which are arranged in the inner peripheral area to maintain space between the front substrate and the rear substrate.
(19) A display device as described in (18), wherein the outer spacers are formed in the inner part of the inner peripheral area where both the black matrix and the metal back are present.

According to the configuration of (1), outer spacers arranged around the effective screen area make it possible to control the distance between the front and rear substrates without depending on the frame which constitutes a vacuum envelope. Therefore, it is possible to solve the problems which may occur if the distance between the front and rear substrates is not uniform.

According to the configuration of (2), since plate-shaped spacers are used, it is possible to more accurately control the distance between the front and rear substrates.

According to the configuration of (3), it is advantageous in manufacturing cost since the inner and outer spacers can be prepared as the same components.

According to the configuration of (4), since the outer spacers are higher than the inner spacers, it is possible to accurately control the distance between the front and rear substrates even if the amount of the sealing material applied to the frame is considerably increased. According to the configuration of any of (5) through (12), the outer spacers can work more reliably.

According to the configuration of any of (13) through (15), since a certain voltage can be supplied to the outer spacers from the rear substrate, electrification of the outer spacers can be prevented. Therefore it is possible to not only suppress influence of the outer spacers upon electron beams but also prevent sparks around the outer spacers.

According to the configuration of (16) or (17), since a positive electrode voltage can be supplied to the outer spacers from the black matrix formed on the front substrate, electrification of the outer spacers can be prevented. Therefore it is possible to not only suppress influence of the outer spacers upon electron beams but also prevent sparks around the outer spacers.

According to the configuration of (18) or (19), since a positive electrode voltage can be supplied to the outer spacers from the metal back formed on the front substrate, electrification of the outer spacers can be prevented. Therefore it is possible to not only suppress influence of the outer spacers upon electron beams but also prevent sparks around the outer spacers.

### BRIEF DESCRIPTION OF THE DRAWINGS

FIG. 1 is provided to illustrate the configuration of an image display device according to a first embodiment of the present invention. FIG. 1A is a top view as viewed from the front substrate side. FIG. 1B is a side view of the device shown in FIG. 1A.

FIG. 2 schematically shows a top view of the rear substrate with the front substrate removed.

FIG. 3 schematically shows a cross-section of the rear substrate taken along line B-B of FIG. 2 FIG. 4 schematically shows another example of the cross-section of the rear substrate taken along line C-C of FIG. 2 including the associated portion of the front substrate.

FIG. 5 schematically shows another example of the cross section of the rear substrate taken along line C-C of FIG. 2 including the associated portion of the front substrate.

FIG. 6 schematically shows another example of the cross section of the rear substrate taken along line C-C of FIG. 2 including the associated portion of the front substrate.

FIG. 7 schematically shows another example of the cross section of the rear substrate taken along line C-C of FIG. 2 including the associated portion of the front substrate.

FIG. 8 schematically shows another example of the cross section of the rear substrate taken along line C-C of FIG. 2 including the associated portion of the front substrate.

FIG. 9 schematically shows another example of the cross section of the rear substrate taken along line C-C of FIG. 2 including the associated portion of the front substrate.

FIG. 10 schematically shows a cross section of a third embodiment of the present invention.

FIG. 11 schematically shows a cross section of a fourth embodiment of the present invention.

FIG. 12 schematically shows a cross section of a fifth embodiment of the present invention.

FIG. 13 schematically shows a cross section of a sixth embodiment of the present invention.

FIG. 14 schematically shows a cross section of the sixth embodiment of the present invention.

FIG. 15 schematically shows a cross section of a seventh embodiment of the present invention.

### DETAILED DESCRIPTION OF THE PREFERRED EMBODIMENTS

With reference to the drawings of embodiments, the following will provide a detailed description of the best mode for carrying out the present invention.

### First Embodiment

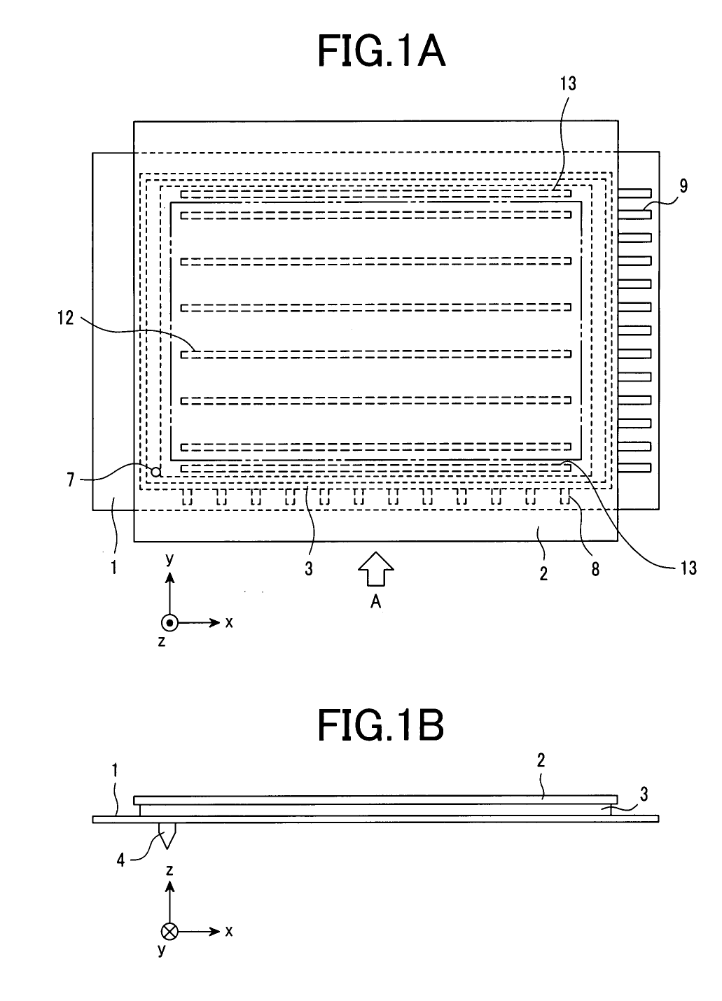

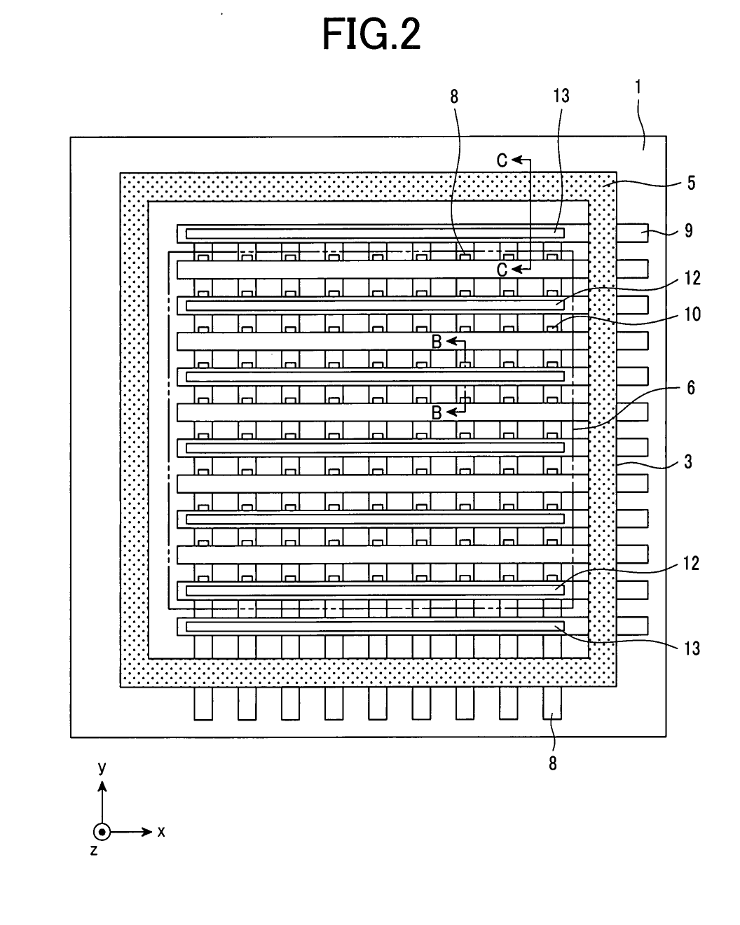

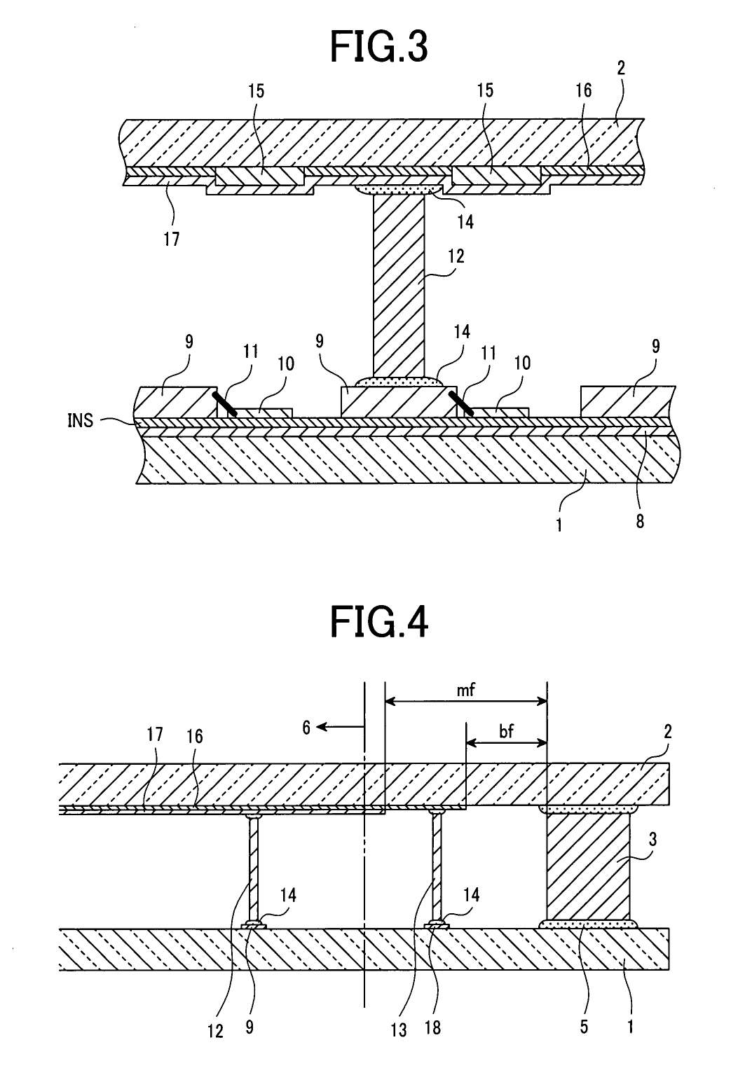

FIG. 1 and FIG. 2 are provided to illustrate the configuration of an image display device according to a first embodiment of the present invention. FIG. 1A is a top view as viewed from the side of a front substrate 2. FIG. 1B is a side view as viewed in the direction of arrow A of FIG. 1A. FIG. 2 schematically shows a top view of a rear substrate 3 with the front substrate 2 removed. FIG. 3 schematically shows an enlarged cross-section of a rear substrate 1 taken along line B-B of FIG. 2 including the associated portion of the front substrate 2. In FIG. 3, electron sources are omitted. FIG. 4 schematically shows a cross section of the rear substrate 1 cut along line C-C of FIG. 2 including the associated portion of the front substrate 2. In FIG. 4, phosphors 15 are omitted.

The front substrate 2 and rear substrate 1 in FIGS. 1 through 4 are formed of about 3 mm thick glass plates. By a peripheral frame 3, a space of about 3 mm is kept between the front substrate 2 and the rear substrate 1. This frame 3 is, for example, a sintered block composed of glass, ceramic and frit glass. The frame 3 has a thickness of, for example, about 5 mm to 9 mm. An envelope of the display device is constructed by bonding this frame 3 to the front substrate 1 and the rear substrate 1 by using a sealing material 5. Typically, frit glass is used as the sealing material 5.

The space surrounded by the front substrate 2, rear substrate 1 and frame 3 is evacuated to a vacuum of, for example, about 10⁻³-10⁻⁵ Pa via an evacuation tube 4. The evacuation tube 4 communicates with a through hole 7 which formed through the rear substrate 1. After gas is completely evacuated from the envelope, the evacuation tube 4 is chipped off to seal the envelope.

On the inner side of the rear substrate 1, signal lines 8 are extended in the Y direction and arranged in the X direction. Over the signal lines 8, an inter-layer insulation film INS is formed. On the inter-layer insulation film INS, scan lines 9 are extended in the X direction and arranged in the Y direction. An electron source 10 is located in the vicinity of each intersection of the signal lines 8 and scan lines 9. In the present embodiment, electron sources 10 are located above signal lines 8. A scan line 9 is electrically connected with electron sources 8 by connection electrodes 11. In association with a great number of electron sources 10 formed on the rear substrate 1, phosphors 15 are formed on the font substrate 2 as shown in FIG. 3. To raise the contrast, a black matrix (BM 16) is usually formed so as to surround each phosphor 15 by the black substance. Usually, the BM 16 is conductive since its main component is carbon. Further, a metal back 17 made of Al film is formed to keep the inner side of the front substrate 2 at a positive electrode voltage. The positive electrode voltage is about 8 KW to 10 KV and the metal back 17 is about 800 angstroms thick. An area where phosphors 15 are formed in association with electron sources 10 is the effective screen 6.

Once the envelope is vacuumized, a given distance cannot be maintained between the front substrate 2 and the rear substrate 1 since the two substrates are distorted by the atmospheric pressure. Inner spacers 12 are formed within the effective display area to prevent this. Generally, the inner spacers 12 have the same height as the frame 3. In the present embodiment, their height is 3 mm. The inner spacers 12 are as thin as about 0.1 mm while the frame 3 has a large thickness of 5 mm to 9 mm. The inner spacers 12 are made of ceramic or glass. The inner spacers 12 are bonded to the front substrate 2 and rear substrate 1 by using a bonding material 14. Generally, frit glass is used as the bonding material 14. These inner spacers 12 may be changed flexibly in shape and arrangement according to the display device's size and the like. Although long spacers are laid on scan lines 9 in the present embodiment, it is also possible to lay a plurality of shorter inner spacers 12 in the horizontal direction of the screen or lay them in the vertical direction as shown in other embodiments.

As shown in FIG. 3, an inner spacer 12 is bonded to the metal back 17 on the front substrate 2 via the bonding material 14 and to a scan line 9 on the rear substrate 1 via the bonding material 14. If the inner spacer 12 is dielectric, the inner spacer 12 is charged by electrons from a electron source 10. The charged inner spacer 12 exerts influence on the electron beam. The electron beam may miss the target phosphor 15. If so, the utilization efficiency of the electron beam is lowered. In addition, the electron beam may bombard another phosphor 15 to deteriorate color purity.

To prevent this, the inner spacers 12 are made of a material having a resistivity of about 10⁸-10⁹ Ω·cm. This conductivity, though very low, prevents the inner spacers 12 from being charged. Alternatively, if the inner spacers 12 are dielectric, they are coated with a high resistivity film to prevent their electrification. That is, a small amount of current is applied to the inner spacers 12 to prevent their electrification. To apply current to an inner spacer 12, the bonding material 14 is required to be conductive. Thus, conductivity is given to the bonding material 14 by, for example, distributing Ag or the like in a frit glass. To steadily apply current to the inner spacer 12, although the amount of current may be very small, the bonding material 14 must provide reliable electrical connection between the inner spacer 12 and the scan line 9 or the metal back 17. The sealing material 5 used to bond the frame 3 to the front substrate 2 and to the rear substrate 1 is a frit glass. As well, the bonding material 14 used for bonding with the front substrate 2 and rear substrate 1 is a frit glass although conductive substance is distributed therein. The process to bond the frame 3 and inner spacers 12 respectively to the front panel 2 and rear panel 1 by frit glasses is performed by frit bake. In this frit bake process, the ambient temperature is kept at about 430° C. for about 30 minutes to melt the frit glasses and then gradual cooling down is made to solidify the frit glasses, resulting in the frame 3 and inner spacers 12 bonded respectively to the front substrate 2 and rear substrate 1.

Ideally and preferably, the distance between the front substrate 2 and the rear substrate 1 measured around the effective screen 6 is not different from the distance measured within the effective screen 6. Within the effective screen 6, this distance is the sum of the height of the spacer and the thickness of the bonding material 14. Around the effective screen 6, the distance is the sum of the height of the frame 3 and the thickness of the sealing material 5. From the viewpoint of adhesivity and fixation, the thickness of the bonding material 14 for inner spacers 12 is designed to be several μm or larger and preferably 10-40 μm although this depends on the composition. The sealing material 5 for the frame 3 is designed to be a little thicker than the bonding material 14 for inner spacers 12 since reliable air-tightness must be secured. The design thickness of the bonding material 14 for the inner spaces 12 and that of the sealing material 5 for the frame 3 are set so that the total height of the frame 3 around the effective screen 6 becomes equal to that of the inner spacers 12. Practically, however, it is very difficult to control their thicknesses. For example, the frame 3 is 5 mm thick while each inner spacer 12 is about 0.1 mm thick. Between them, there is a large difference in thermal capacity. Therefore, liquefying pasty frit glass by raising the ambient temperature or keeping the ambient temperature at a certain level in a frit glass bake oven causes the frit glass for inner spacers 12 and the frit glass for the frame 3 to begin to liquefy respectively at different times even if the same frit glass is used. If liquefied, frit glass protrudes around each inner spacer 12 or the frame 3. The amount of protrusion may be a factor of varying the distance between the front substrate 2 and the rear substrate 1. The amount of protrusion is subject to the times when frit glass begins to liquefy and solidify. In the case of an inner spacer 12, if the amount of protrusion is not sufficient, the inner spacer 12 is not firmly bonded to the front substrate 2 or the rear substrate 1. If the inner spacer 12 is not firmly bonded to the front substrate 2 or the rear substrate 1, electrical connection with the front substrate 2 or the rear substrate 1 is poor and consequently the electrified inner spacer 12 may deflect the ion beam and cause such problems as deteriorated color purity as mentioned above. In the case of the frame 3, if the amount of protrusion is insufficient, adequate air-tightness cannot be secured. The amount of frit glass application may be increased so that the inner spacers 12 can be bonded firmly or adequate air-tightness can be secured by the frame 3. However, this makes difficult the distance control. The above-mentioned problems are attributable to the frame 3 which is given another function to control the distance between the front substrate 2 and the rear substrate although its main function is to secure air-tightness. The present invention, as shown in FIGS. 1, 2 and 4, is characterized in that outer spacers 13 are located outside the effective screen 6 and these outer spaces 13 control the distance between the front substrate 2 and the rear substrate 1 in the peripheral area of the panel. In the present embodiment, shown in FIG. 1, outer spacers 13 are found above and below the effective screen 6. The outer spacers 13 according to the present embodiment are equal to the inner spacers 12 in terms of thickness, length, height and the like. Making the inner spacers 12 and the outer spacers 13 identical with each other contributes to standardization of components and prevention of mistakes.

As shown in FIGS. 1, 2 and 4, the present embodiment is characterized in that dummy scan lines 189 are laid on the rear substrate 1 and outer spacers 13 are laid on these dummy scan lines 189. A certain voltage is applied to these dummy lines 189. As this voltage, for example, 0 V may be applied. The value of 0 V is the voltage which is applied to each scan line 9 when the line is not selected. Similar to the inner spacers 12, the outer spacers 13 are made of a conductive material or, if not, are coated with a conductive substance. On the front substrate 2 side, the outer spacer 13 is in contact with the BM 16. On the front substrate 2, the BM 16 is wider than the metal back 17 serving as the positive electrode. For example, as shown in FIG. 4, the distance mf from the end of the BM 16 to the frame 3 is about 15-20 mm whereas the distance bf from the end of the BM 16 to the frame 3 is about 10-15 mm. Therefore, the BM 16 provides a space enough large to arrange an outer spacer 13 thereon. The BM 16 is conductive since its main component is carbon. Similar to inner spacers 13, if a conductive frit glass is used to bond the outer spacer 13 to the dummy scan line 189 and BM 16, it is possible to apply a small amount of current to the outer spacer 13 in order to prevent the outer spacer 13 from being electrified. Although the electrification does not exert significant influence on electron beams since the outer spacer 13 is distant from the electron beams, preventing the electrification is effective to prevent sparks around the outer spacer 13.

### Second Embodiment

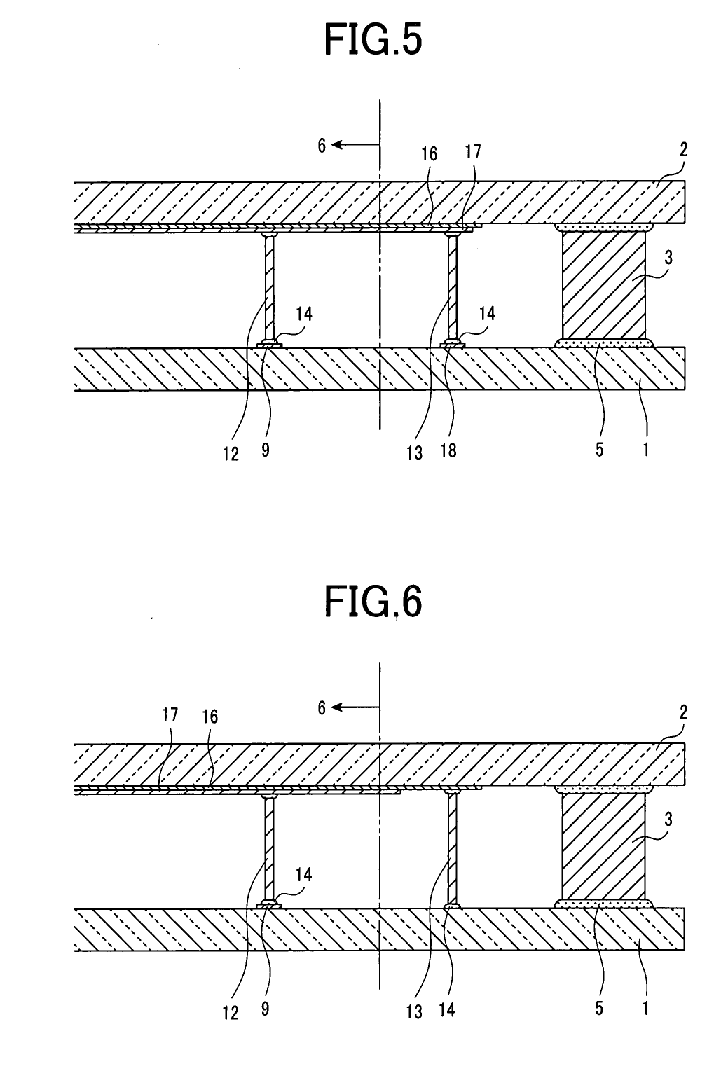

The present embodiment shows examples of how outer spaces are arranged. In the first embodiment, as shown in FIG. 4, an outer spacer 13 is bonded to a dummy scan line 18 on the rear substrate 1 and to the BM 16 on the front substrate 2. Shown in FIG. 5 is an example where an outer spacer 13 is bonded to the metal back 17 instead of the BM 16. On the front substrate 2 side, the inner spacer 12 is also bonded to the metal back 17 as shown in FIG. 3. Thus, there is no difference in terms of bonding condition between the inner spacers 12 and the outer spacers 13. The BM film 16, which exists below the metal back 17 as shown in FIG. 5, may be eliminated. Although the metal back film 17 is as thin as 800 angstroms, there occurs no problem since almost no current flows through the outer spacers 13.

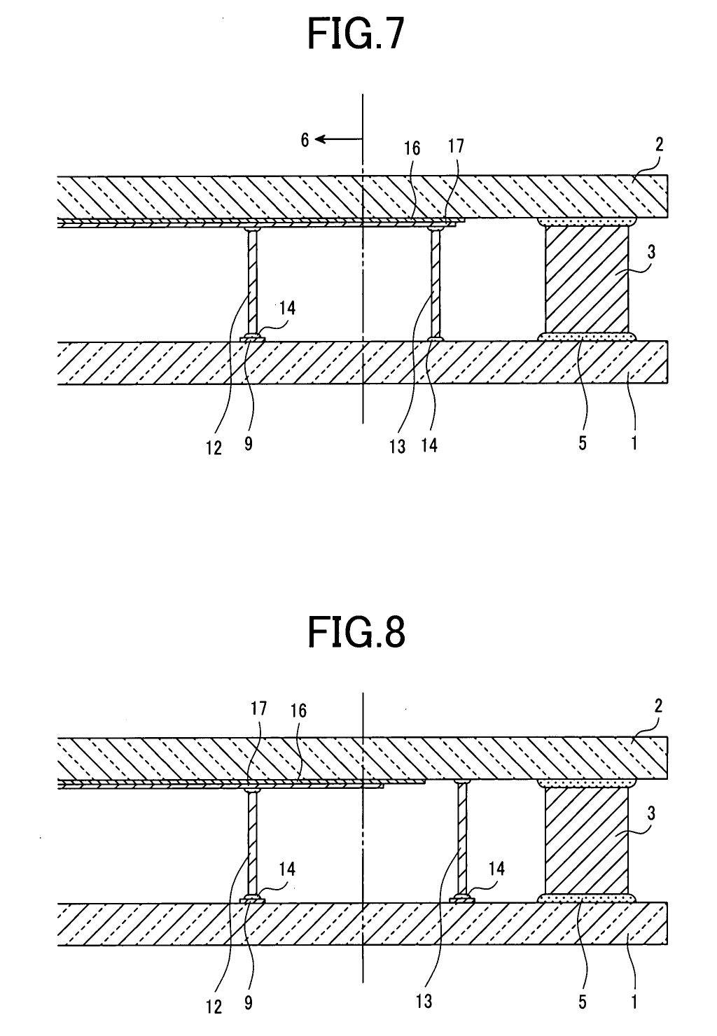

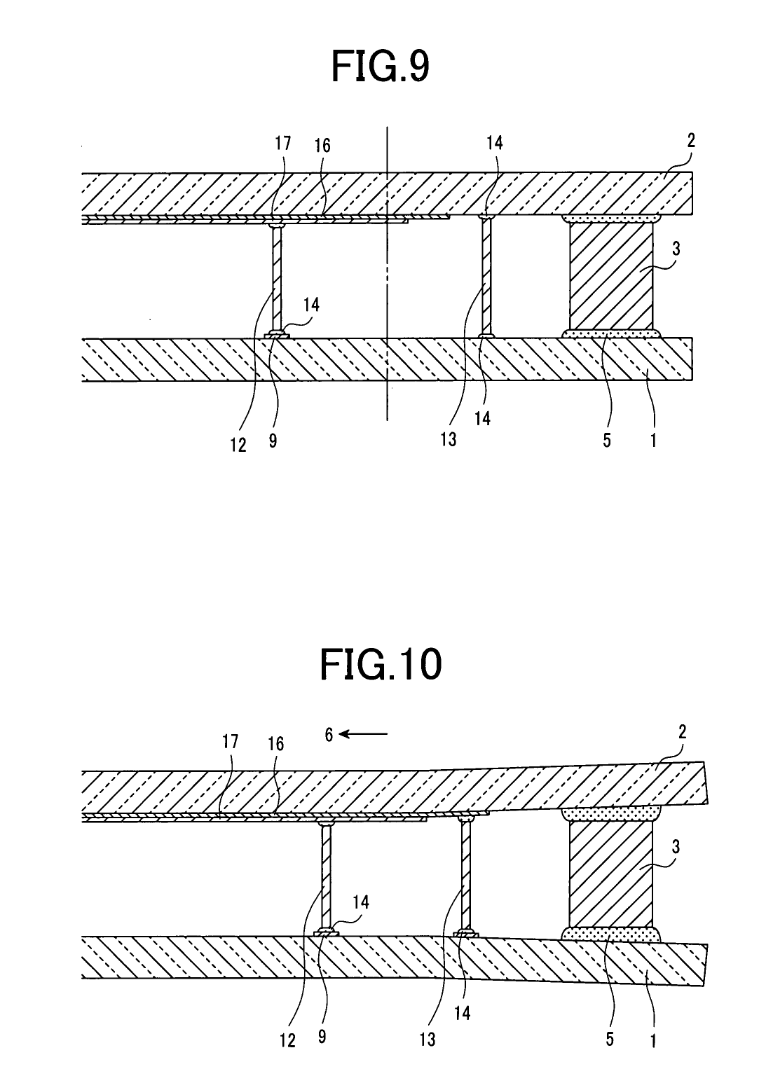

FIG. 6 shows an example where the rear substrate 1 has no dummy scan line 18 formed thereon for an outer spacer 13 while the outer spacer 13 is bonded to the BM 16 on the front substrate 2. Since the outer spacer 13 is electrically floating on the rear substrate 1, no current is applied to the outer spacer 13. However, since a certain voltage, the positive electrode voltage in this case, is applied to the outer spacer 13, the outer spacer 13 is not electrified to an indefinite voltage. In this case, however, care must be directed to the withstand voltage around the outer spacer 13 since the outer spacer 13 may have a high voltage. FIG. 7 shows an example where the outer spacer 13 is bonded to the metal back 17 on the front substrate 2. As mentioned above in reference with FIG. 5, this can also be implemented without problems. In addition, although the metal back 17 is overlapped with the BM 16 where the outer spacer 13 is bonded in FIG. 7, it is also possible as described with FIG. 5 to bond the outer spacer 13 where only the metal back 17 is formed if the metal back 17 is formed wider. FIG. 8 shows an example where an outer spacer 13 is bonded to a dummy scan line 189 on the rear substrate 1 and directly to the front substrate 2. In this case, no current flows since the outer spacer 13 is electrically floating on the front substrate 2. However, the voltage of the dummy scan line 18, for example, 0V, is applied, the outer spacer 13 is not electrified. In this case, however, care must be directed to sparks which may occur between the outer spacer 13 and the metal back 17 or the like on the front substrate 2. FIG. 9 shows an example where both rear substrate 1 and front substrate 2 cannot apply voltage to the outer spacer 13. In this case, the outer spacer 13 is often laid near the frame 3. Since no voltage is applied to the outer spacer 13, the outer spacer 13 is electrified. However, this doesn't cause a serious problem since the outer spacer 13 is much distant from the electron beam. In addition, even if the outer spacer 13 is electrified, the electron beam's trajectory is not much influenced due to the large distance from the electron beam. If the outer spacer 13 is 3 mm or more distant from the effective screen 6, no significant influence is given to the electron beam's trajectory even if the outer spacer 13 is electrified.

### Third Embodiment

To secure air-tightness, it may be desirable to increase the amount of the sealing material 5 used to bond the frame 3 to the front substrate 2 and the rear substrate 1. Unfavorably, however, increasing the amount of the sealing material 5 for the frame makes the distance control more difficult. In this case, the distance between the front substrate 2 and the rear substrate 1 is likely to be larger where the frame 3 is arranged. This is schematically shown in FIG. 10. In the present embodiment, the outer spacer 13 is designed to be higher than the inner spacer 12 so as to gradually decrease the inter-substrate distance toward the center of the panel. Practically, the outer spacer 13 is designed to be 10 μm-50 μm higher than the inner spacer 12. The key point of the present embodiment is that the distance between the front substrate 2 and the rear substrate 1 in the peripheral area is controlled by the outer spacers 13. That is, since both outer spacers 13 and inner spacers 12 have the same thickness, the frit glass layers applied to them begin to liquefy/solidify almost simultaneously, making it possible to equally control the thickness of the bonding material 14 for outer spacers 13 and that for inner spacers 12. It is therefore possible to prevent inner spacers 12 from suffering poor electrical connection which is conventionally inevitable.

### Fourth Embodiment

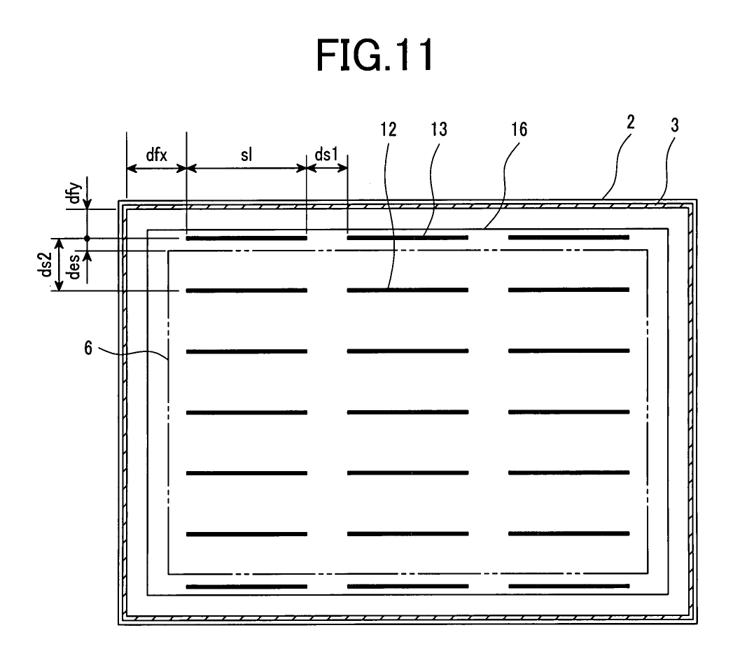

FIG. 11 shows a fourth embodiment of the present invention. While long inner spacers 13 are employed in the first embodiment, the present embodiment has plural short outer spacers 13 and inner spacers 12 laid horizontally in line. In the present embodiment, the horizontal arrangement of the outer spacers 13 is same as that of the inner spacers 12. To control the distance between the front substrate 2 and the rear substrate 1, it is rational to employ the same arrangement in the horizontal direction. The outer spacers 13 in the present embodiment are bonded to the front substrate 2 where the BM 16 is formed outside the effective screen 6. Needless to say, although the spacers are arranged in three columns in FIG. 11, it is not necessary to limit the number of columns to three. In addition, although the inner spacers 12 and outer spacers 13 have the same thickness of 0.1 mm, their thickness design is not limited to this. Also note that each of the distances mentioned below indicates an edge-to-edge distance, not a center-to-center distance.

In FIG. 11, s1 which is the length of each spacer may vary widely depending on the screen size, working efficiency, etc. In the case of a 15 inch diagonal screen, for example, s1 is about 20 mm-30 mm. A distance ds1 is the distance between outer spacers 13. The distance ds1 is about 3 mm-50 mm and preferably about 3 mm-20 mm. Making this spacer interval too wide causes a risk that the front or rear glass may crack due to the atmospheric pressure. Distances dfx and dfy are distances of each outer spacer 13 from the frame 3. The distances dfx and dfy are preferably about 3 mm-50 mm and more preferably about 10 mm-40 mm. A distance ds2 is the outer-to-inner spacer distance. The distance ds2 is preferably about 3 mm-50 mm and more preferably about 10 mm-40 mm. It is not allowed to excessively widen the frame to outer spacer distance and the outer spacer to inner spacer distance since this causes a risk that the front or rear glass may be cracked by the atmospheric pressure.

A distance des is the distance between each outer spacer 13 and the effective screen. Preferably, the distance des is 3 mm or wider. Structurally, it is not always possible to prevent an outer spacer 13 from being electrified by applying a small amount of current. If the outer spacer 13 is at least 3 mm distant from the effective screen, the electron beam is hardly influenced even if the outer spacer 13 is electrified.

### Fifth Embodiment

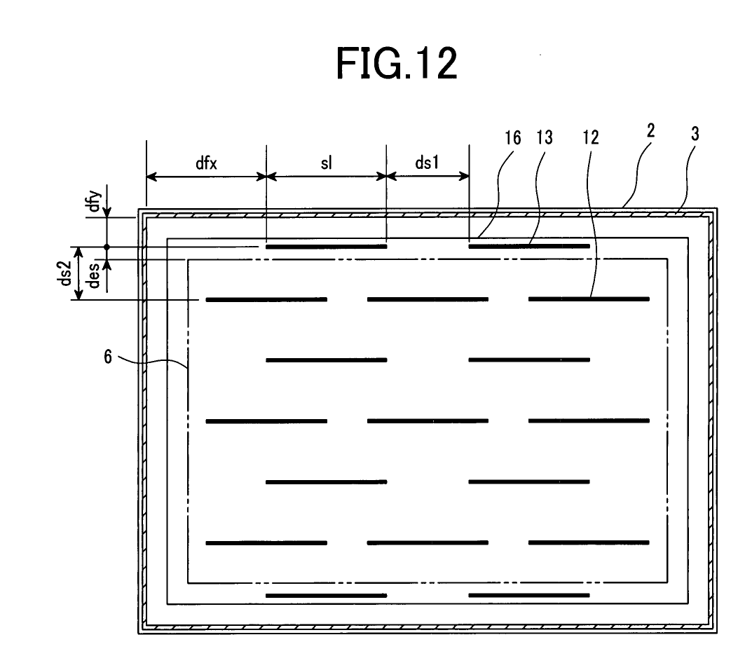

FIG. 12 shows a fifth embodiment of the present invention. In the present embodiment, the inner spacers 12 are located in a zigzag arrangement. The outer spacers 13 are also located according to this arrangement rule. Needless to say, although three columns are combined with two columns in the zigzag arrangement in FIG. 12, it is not necessary to limit the arrangement to this pattern.

What are mentioned above concerning the thickness of outer spacer 13, length s1 of outer spacer 13, distance ds1 between outer spacers 13, distance ds2 between outer spacer 13 and inner spacer 12, distances dfx and dfy between outer spacer 13 and the frame 3 and distance des between the effective screen and outer spacer 13 in the fourth embodiment are also applicable to the present embodiment.

### Sixth Embodiment

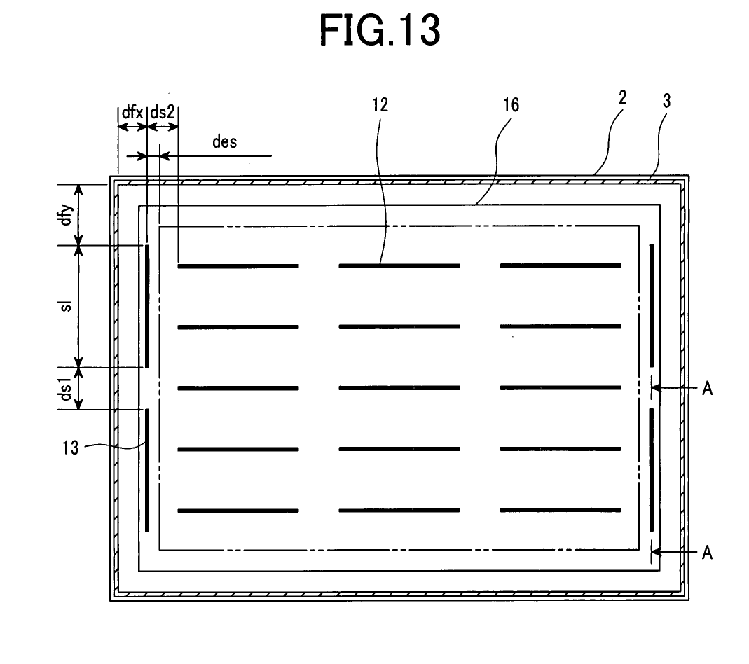

FIG. 13 shows a sixth embodiment of the present invention. In the present embodiment, outer spacers 13 are laid vertically along the short-sides. Needless to say, although two outer spacers 13 are provided per short side in the present, it is not necessary to limit this number to 2. As well, although the inner spacers 12 are arranged in three columns, it is not necessary to limit the arrangement of the inner spacers 12 to this.

Although the outer spacers 13 are laid vertically, what are mentioned above concerning the thickness of outer spacer 13, length s1 of outer spacer 13, distance ds1 between outer spacers 13, distance ds2 between outer spacer 13 and inner spacer 12, distances dfx and dfy between outer spacer 13 and the frame 3 and distance des between the effective screen and outer spacer 13 in the fourth embodiment are also applicable to the present embodiment.

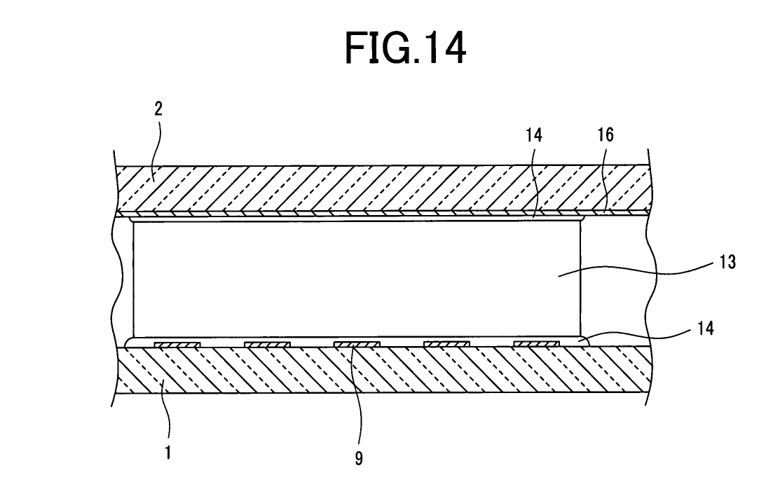

FIG. 14 shows a cross section taken along line A-A of FIG. 13. In the present embodiment, it must be noted that as shown in FIG. 14, an outer spacer 13 is laid across scan lines 9. That is, the outer spacer 13 is not allowed to provide electrical connection between scan lines 9. Therefore, the bonding material 14, at least on the rear substrate 1 side must be dielectric. To apply a small amount of current between the front substrate 2 and a scan line 9 in order to prevent the outer spacer 13 from being electrified, the bonding material 14 on the rear substrate 1 side is required to be somewhat conductive. In this case, the bonding material 14 must have an enough large resistivity of, for example, about 10⁸-10⁹ Ω·cm not to distort the scan voltage applied to scan lines 9.

### Seventh Embodiment

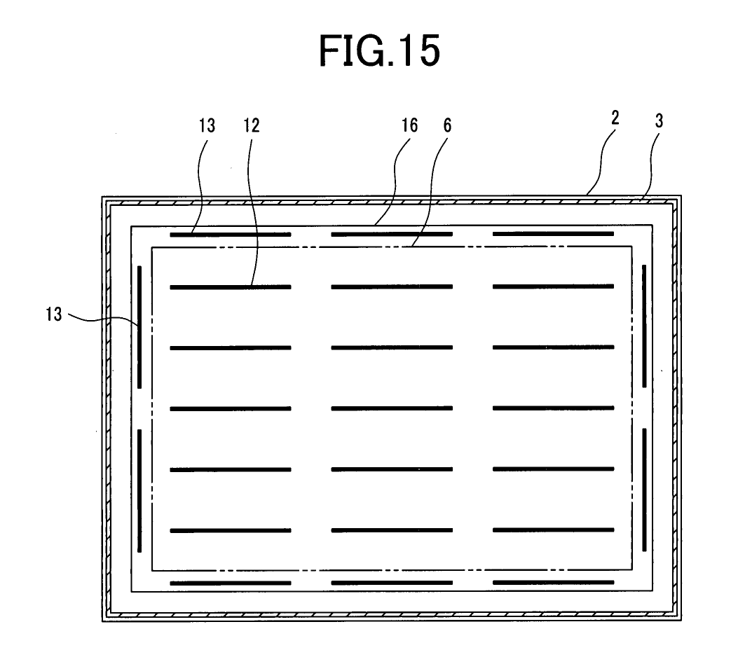

FIG. 15 shows a seventh embodiment of the present invention. The present embodiment is characterized in that the screen is surrounded on all four sides by outer spacers 13. This makes it possible to reliably control the distance between the front substrate 2 and the rear substrate 1 across the whole screen. Needless to say, although each horizontal/vertical side has three/two outer spacers 13 in the present embodiment, it is possible to change the number, arrangement and others of the outer spacers 13.

Although the outer spacers 13 include both horizontal and vertical ones, what are mentioned above concerning the thickness of outer spacer 13, length s1 of outer spacer 13, distance ds1 between outer spacers 13, distance ds2 between outer spacer 13 and inner spacer 12, distances dfx and dfy between outer spacer 13 and the frame 3 and distance des between the effective screen and outer spacer 13 in the fourth embodiment are also applicable to the present embodiment. In addition, requirements mentioned above on the sixth embodiment are also applicable to the vertically laid spacers.

What is claimed is:

1. A display device comprising:
a front substrate;
a rear substrate;
a peripheral frame that is provided between the front substrate and the rear substrate and constitutes an envelope to maintain a vacuum therein;
electron sources arranged in a matrix on the rear substrate;
phosphors arranged on the front substrate in association with the electron sources;
an effective screen area which is constituted of the electron sources arranged in a matrix and the phosphors;
a peripheral area between the effective screen area and the frame;
inner spacers which are arranged in the effective screen area to maintain a space between the front substrate and the rear substrate; and
outer spacers which are arranged in the peripheral area to maintain the space between the front substrate and the rear substrate.

2. A display device according to claim 1 wherein the inner spacers and the outer spacers are plate-like spacers.

3. A display device according to claim 1 wherein the inner spacers and the outer spacers are plate-like spacers and the inner spacers and the outer spacers are the same in terms of length, thickness and height.

4. A display device according to claim 1 wherein the outer spacers are higher than the inner spacers.

5. A display device according to claim 1 wherein the outer spacers are higher than the inner spacers by 10 μm-50 μm.

6. A display device according to claim 2 wherein each of the outer spacers has a length of 20 mm or more.

7. A display device according to claim 1 wherein the outer spacers are arranged at intervals of 3 mm-50 mm.

8. A display device according to claim 1 wherein the inner spacers are arranged at intervals of 3 mm-50 mm.

9. A display device according to claim 1 wherein the outer spacers are distant from the frame by 3 mm-50 mm.

10. A display device according to claim 1 wherein the outer spacers are distant from the effective screen area by 3 mm or more.

11. A display device according to claim 2 wherein the outer spacers are laid in parallel with the inner spacers.

12. A display device according to claim 2 wherein the outer spacers are laid orthogonally to the inner spacers.

13. A display device comprising:
a front substrate;
a rear substrate;
a peripheral frame that is provided between the front substrate and the rear substrate and constitutes an envelope to maintain a vacuum therein;
plural image signal lines which are laid in a first direction and arranged in a second direction on the rear substrate;
plural scan lines which are laid in the second direction and arranged in the first direction on the rear substrate; electron sources each of which is formed in the vicinity of an intersection of the scan lines and the image signal lines;
phosphors which are arranged on the front substrate in association with the electron sources;
an effective screen area which is constituted of the electron sources arranged in a matrix and the phosphors;
a peripheral area between the effective screen area and the frame;
inner spacers which are arranged in the effective screen area to maintain a space between the front substrate and the rear substrate; and
outer spacers which are arranged in the peripheral area to maintain the space between the front substrate and the rear substrate.

14. A display device according to claim 13 wherein the inner spacers are plate-like spacers which are formed respectively on some of the scan lines.

15. A display device according to claim 13 wherein the outer spacers are laid on dummy scan lines formed in parallel with the scan lines on the rear substrate; and the outer spacers are electrically connected with the dummy scan lines and a certain voltage is applied to the dummy scan lines.

16. A display device comprising:
a front substrate;
a rear substrate;
a peripheral frame that is provided between the front substrate and the rear substrate and constitutes an envelope to maintain a vacuum therein;
plural image signal lines which are laid in a first direction and arranged in a second direction on the rear substrate;
plural scan lines which are laid in the second direction and arranged in the first direction on the rear substrate;
electron sources each of which is formed in the vicinity of an intersection of the scan lines and the image signal lines;
phosphors which are arranged on the front substrate in association with the electron sources;
a black matrix which is formed so as to surround each of the phosphors;
an effective screen area which is constituted of the electron sources arranged in a matrix and the phosphors;
a peripheral area between the effective screen area and the frame, including an inner peripheral area where the black matrix is extended beyond the effective screen area;
inner spacers which are arranged in the effective screen area to maintain a space between the front substrate and the rear substrate; and
outer spacers which are arranged in the inner peripheral area to maintain the space between the front substrate and the rear substrate.

17. A display device according to claim 16 wherein the outer spacers are electrically connected with the black matrix.

18. A display device comprising:
a front substrate;
a rear substrate;
a peripheral frame that is provided between the front substrate and the rear substrate and constitutes an envelope to maintain a vacuum therein;
plural image signal lines which are laid in a first direction and arranged in a second direction on the rear substrate;
plural scan lines which are laid in the second direction and arranged in the first direction on the rear substrate;
electron sources each of which is formed in the vicinity of an intersection of the scan lines and the image signal lines;
phosphors which are arranged on the front substrate in association with the electron sources;
a black matrix which is formed so as to surround each of the phosphors;
a metal back which is formed as to cover the phosphors and the black matrix;
an effective screen area which is constituted of the electron sources arranged in a matrix and the phosphors;
a peripheral area between the effective screen area and the frame, including an inner peripheral area where the black matrix and the metal back are extended beyond the effective screen area;
inner spacers which are arranged in the effective screen area to maintain a space between the front substrate and the rear substrate; and
outer spacers which are arranged in the inner peripheral area to maintain the space between the front substrate and the rear substrate.

19. A display device according to claim 18 wherein the outer spacers are formed in the inner part of the inner peripheral area where both the black matrix and the metal back are present.
